(19) United States
(12) Patent Application Publication
(10) Pub. No.: US 2017/0032417 A1
(43) Pub. Date: Feb. 2, 2017

(54) DETECTING AND GENERATING ONLINE BEHAVIOR FROM A CLICKSTREAM

(71) Applicant: International Business machines Corporation, Armonk, NY (US)

(72) Inventors: Hagop Amendjian, Quebec (CA); Peter H. Burton, Vancouver (CA); Donna K. Byron, Petersham, MA (US); Manvendra Gupta, Brampton (CA)

(21) Appl. No.: 14/815,968

(22) Filed: Aug. 1, 2015

(51) Int. Cl. G06Q 30/02

(52) U.S. Cl. CPC G06Q 30/0254

(57) ABSTRACT

A method, computer program product and system of detecting and generating online behavior from a clickstream. The method includes learning a user's present stage of online behavior wherein there are a plurality of stages of online behavior from exploring at least one product or service to purchasing at least one product or service; responsive to learning the user's present stage of online behavior, predicting a user's future stage of online purchasing behavior; and providing a targeted online action to the user in conjunction with predicting the user's future stage of online purchasing behavior to influence the user to a next stage of online behavior. Also disclosed is a computer program product.

### BACKGROUND

The present exemplary embodiments pertain to online behavior of users of computer systems and, more particularly, relate to detecting that online behavior and generating actions to influence a user toward purchasing a product or service or completing a transaction.

People increasingly use their computers and the Internet to research and purchase products. For example, users may go online to determine which products are available to fulfill a particular need. In conducting such research, a user may enter search terms related to the need or product category into a search engine. They may explore various websites that are returned by the search engine to determine which products are available. After identifying a product that they believe is suitable, they may do more in depth research about the product, identify which retailers sell the product, compare prices between various sources, look for coupons or sales, etc. A portion of the users will eventually purchase the product online. Another segment of users will use the information gained through their online research in making an in-person purchase at a bricks-and-mortar store.

### BRIEF SUMMARY

The various advantages and purposes of the exemplary embodiments as described above and hereafter are achieved by providing, according to a first aspect of the exemplary embodiments, a method of detecting and generating online behavior from a clickstream including: learning a user's present stage of online behavior wherein there are a plurality of stages of online behavior from exploring at least one product or service to purchasing at least one product or service; responsive to learning the user's present stage of online behavior, predicting a user's future stage of online purchasing behavior; and providing a targeted online action to the user in conjunction with predicting the user's future stage of online purchasing behavior to influence the user to a next stage of online behavior.

According to a second aspect of the exemplary embodiments, there is provided a computer program product for detecting and generating online behavior from a clickstream comprising a computer readable storage medium having program instructions embodied therewith, the program instructions executable by a computer to cause the computer to perform a method including: learning a user's present stage of online behavior wherein there are a plurality of stages of online behavior from exploring at least one product or service to purchasing at least one product or service; responsive to learning the user's present stage of online behavior, predicting a user's future stage of online purchasing behavior; and providing a targeted online action to the user in conjunction with predicting the user's future stage of online purchasing behavior to influence the user to a next stage of online behavior.

According to a third aspect of the exemplary embodiments, there is provided a system for detecting and generating online behavior from a clickstream which includes a specially programmed computer device. The specially programmed computer device having a computer readable storage medium, the computer readable storage medium having program instructions embodied therewith, the program instructions executable by the specially programmed computer device to cause the specially programmed computer device to perform a method including: learning a user's present stage of online behavior wherein there are a plurality of stages of online behavior from exploring at least one product or service to purchasing at least one product or service; responsive to learning the user's present stage of online behavior, predicting a user's future stage of online purchasing behavior; and providing a targeted online action to the user in conjunction with predicting the user's future stage of online purchasing behavior to influence the user to a next stage of online behavior.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an illustration of a process for detecting a current stage of an online user.

FIG. 2 is an illustration of a process for analyzing text.

FIG. 3 is an illustration of a process for capturing a user's browsing details.

FIG. 4 is an illustration of a process for generating an action to influence a user's online behavior.

FIG. 5 is an illustration of a sample stage/action transition model.

### DETAILED DESCRIPTION

Internet service providers (ISPs) may have a wealth of information about their users, including all URLs (uniform resource locators) visited by a user on any of the user's devices. Additionally, ISPs may have other data about the user such as a user's profile, location data, connection data, etc.

The ISPs may be under pressure to monetize the vast data at their disposal. One of the most temporal and meaningful sources of data is the URLs visited by their users.

The present exemplary embodiments pertain to using the URL data in a user's clickstream to detect the online behavior of the user which may then be monetized by the ISP by generating actions to influence the user's online behavior. A clickstream may be thought of as the recording of the parts of the screen a computer user may click on while web browsing or Internet browsing.

The exemplary embodiments provide a novel mechanism of cross-selling/upselling products and services inexpensively and very efficiently. The exemplary embodiments perform operations that only a computer device may perform in a situation that is very time sensitive.

As a user visits any URL via bookmarks, google/search-engine, manual input of URL, etc., the ISP may track the URLs visited. For each URL, the topic(s) of interest may be determined by a variety of sources. For direct searches, the topics may be extracted via deep NLP (natural language processing). For websites visited by entering data manually or clicking on a bookmark, the topic of interest may have either been predetermined when the user visited that website via a search, or it may be determined by performing an external lookup. The topics extracted may be stored in a topic database to track future visits.

The browsing behavior of the user may be tracked over time taking into consideration metrics such as the breadth of similar keywords/topics searched, the variety of websites visited, the frequency of visits, time spent on each similar keyword. This behavior may be tracked to determine changes in the search and browsing pattern.

A propensity of action may be generated by employing a variety of algorithms such as SVM (support vector machine), Bayes classifier, etc. This propensity may then be used to generate actions to influence the user to a buying decision or may be passed to interested parties.

An important aspect of the exemplary embodiments is to track the user narrowing in on a decision, for example a purchase decision, by passing through a series of stages, where earlier stages may be characterized by wide information exploration and subsequent stages may involve depth rather than breadth. The exemplary embodiments may deliver targeted information to support each decision stage of the buying process. Stages may follow each other in a progression as compared to classification buckets that may have been used in the prior art, which are a discrete forced choice. Stages may be modeled as a Markov network with allowed transitions between stages, and transition probabilities for stage-to-stage transitions. A special stage may be a “final stage” which has no outgoing transition. In one exemplary embodiment, the final stage may be a completed shopping transaction for a product or service and in another exemplary embodiment may be a closed contract. The foregoing exemplary embodiments are for the purpose of illustration and not limitation and there may be other exemplary embodiments not listed here.

To train a stage model, the user's clickstream may need to be partitioned into time windows that may be organized in a linear sequence such as activity at time t, activity at time t+1, etc. The time window as applied hereafter may be appropriate to the use case and may vary from a fraction of a second to minutes or even tens of minutes depending on the context of the user's online behavior, the products searched or the number of clicks performed by the user.

Learned models such as the Viterbi algorithm may be used for such training. The Viterbi algorithm is a dynamic programming algorithm for finding the most likely sequence of hidden stages—called the Viterbi path—that results in a sequence of observed events, especially in the context of Markov information sources and hidden Markov models. Reinforcement learning may also be used for such training.

The output of the exemplary embodiments that use this model is not only to detect the user's current stage but also to hypothesize actions that are likely to advance the user into the next stage. The exemplary embodiments may iterate over a set of possible actions that might be delivered to the user and may select one or more actions that maximize the user's likelihood to progress to the next stage in a sequence that ultimately arrives at a final stage.

Through supervised learning, the exemplary embodiments may learn users' (i.e., users in general) online behavior in each stage of the buying process and apply this learning to the present online user to detect the user's present stage and predict actions that may influence the user to the next stage and eventually to a final stage where the user purchases a product or service or completes a transaction.

Supervised learning is the machine learning task of inferring a function from labeled training data. The training data may consist of a set of training examples. In supervised learning, each example is a pair consisting of an input object (typically a vector) and a desired output value (also called the supervisory signal). A supervised learning algorithm analyzes the training data and produces an inferred function, which may be used for mapping new examples. An optimal scenario will allow for the algorithm to correctly determine the class labels for unseen instances. This requires the learning algorithm to generalize from the training data to unseen situations in a “reasonable” way.

The exemplary embodiments are unlike conventional methods that may classify the user as a likely shopper for a particular product category, and then display material to the user related to that product category. In the conventional methods, there is no differentiation about what kind of intervention to display to the user based on the user's current stage to influence the user to the next stage.

The exemplary embodiments utilize specific breadth versus depth features which are novel and valuable compared to existing techniques.

One feature may be the breadth of exploration within the product category within a particular time window. Detecting this feature utilizes not only straightforward term recognition but also semantic tagging produced by deep document understanding products. For example, car names, car makes, feature names, etc are distinct semantic classes. If the user's search terms and returned documents that the user spent time reading include multiple brands of car, or multiple makes of car, the user would be classified as in an early exploratory phase. Helpful information to push the user into the next phase might be surveys of top-selling car models, ratings, etc, rather than specific prompts from local car dealers, which might be more useful to a shopper in a later price comparison stage.

Another feature may be the depth of exploration within the product category within a particular time window. The level of engagement with a particular product, such as filling in a form to configure sample products, examine price variants, time spent on product website, etc. may indicate the user is in a later stage.

In one exemplary embodiment, there may be four stages in a buying process. In other exemplary embodiments, there may be more or less than four stages. It should be understood that the exemplary embodiments are applicable to many transactional situations regardless of the number of stages. Stage S1 may be the exploring stage in which product offerings and product features are explored which may be characterized by a high number of brands and product makes viewed within a time window. Included within stage S1 may be for example, reading reviews of a variety of products.

Stage S2 may be the evaluation of selected brands and products which may be characterized by narrowed variety and more time spent on details.

Stage S3 may be the selection of a vendor and price comparison for a selected product.

Stage S4 may be the final stage where a product or service may be purchased.

Before considering the possible actions that may be provided to influence a user from one stage to another, it is first necessary to detect the user's current stage. A classification mechanism may be trained to determine each user's stage based on feature values (i.e, examples) extracted from analysis of the user's clickstream and then prepared as supervised learning instances where the appropriate user stage is given as supervised training. Features may be computed within a time slice or time window. The optimal size of the time-window may be determined via experimentation to best-fit the training data.

Stage detection may rely on access to, for example, a category/product/brand lexicon. This lexicon may be induced from a domain specific document collection or created from a product catalog or created by particular brands interested in running the subject analysis. The entity types may be organized into a hierarchy such as product category is a parent of brand is a parent of product id is a parent of feature. The hierarchy may be used to calculate the depth of exploration, that is, the tree depth of an entity type within this hierarchy.

An exemplary embodiment of the stage detection algorithm may, for example, include breadth versus depth features as indicated below.

Breadth features may include, for example:
within each time window, analyze the text of the user's query and visited page contents to determine the variation of exploration, where variation may be calculated as the number of distinct named entities within each level (product/brand/etc.) for each distinct product type;
number of distinct items of each depth level examined during the time window such as eight brand names and eighteen product ids;
change in number of brand names in this time window compared to previous time window;
change in number of features from previous time window;
change in number of product ids from previous time window;
lexical features (indicating words) associated with particular stages such as comparison, ratings, review, annual, best, available, etc.; and
may also use standard topic-identification features.

Depth/concentration features may include for each known named entity term within the lexicon, examining pages the user spends time on and query terms within the time window and evaluate the depth of engagement with that particular entity using features such as:
bookmarking, forwarding, or otherwise persisting link to the page containing keyword;
deep engagement such as user filling in product configuration;
asking questions on user forums or sending a customer support form; and
time spent per article/prorated based on how many different items mentioned on that page.

An example of breadth versus depth may be, for example, a user spent 10 minutes on a form to configure a custom bicycle (all 10 minutes credited to that make of bicycle) vs the user spent 10 minutes reading a comparison of 10 top selling bicycles (each bicycle make credited with 1 minute). The feature representing the number of products examined may also be 1 in the first case and 10 in the second.

Particular values of these features that should be associated with each stage may be determined by the machine learning process, based on labelled training instances provided to the supervised learning.

The probability of a user being in stage X at time t is a function of A) features of the user's activity within the current time window, B) the baseline probability of being in that stage, and C) the allowed stage transitions and probability of transitioning from stage to stage, using the same user's previously detected stage if any.

After detecting the present stage of the user, the exemplary embodiments may provide an action to influence the user to the next stage. Below are listed some possible actions that may be considered at each of the stages, S1 through S4, to influence the user to the next stage. It should be understood that these possible actions are for the purpose of illustration only and are not meant to be limiting in any way.

S1 actions: sample actions during the S1 stage may focus on information and decision support such as:
push marketing materials that detail or expound on particular distinguishing product features;
push promotional/advertising material for any make/model depending on normal ad placement rules;
email user a newsletter from quality/value/feature exploration site such as consumer electronics reviews website;
click bait link for a survey of top-selling product models, ratings, etc,

S2 actions: sample actions during the S2 stage may focus on narrowing the selection of a product such as:
show celebrity endorsements of product or brand;
display link to cross-comparison tools such as price/value comparison sites;
show banner ad for site to configure a customized version of product;
pop up customer service chat for brand;
recommend media that highlights product placement.

S3 actions: sample actions during the S3 stage may focus on persuasion and alleviating potential blockers such as:
display promotional/advertising material for a specific make/model that is available at sales outlet near user;
push sidebar text with recommendations for make/model within the product type that have been uploaded by friends of this shopper;
banner ads for specific local car dealerships;
place ads for ancillary services such as financing offers, free delivery, etc.

S4 actions: Final stage, purchase the product. Once the user is in state S4, the user is essentially across the finish line. Even so, the system could send actions to the user to keep them from undoing the sale, reinforce their decision such as more celebrity endorsements, something that resembles a popup ad that displays a star rating of the item they purchased, etc.

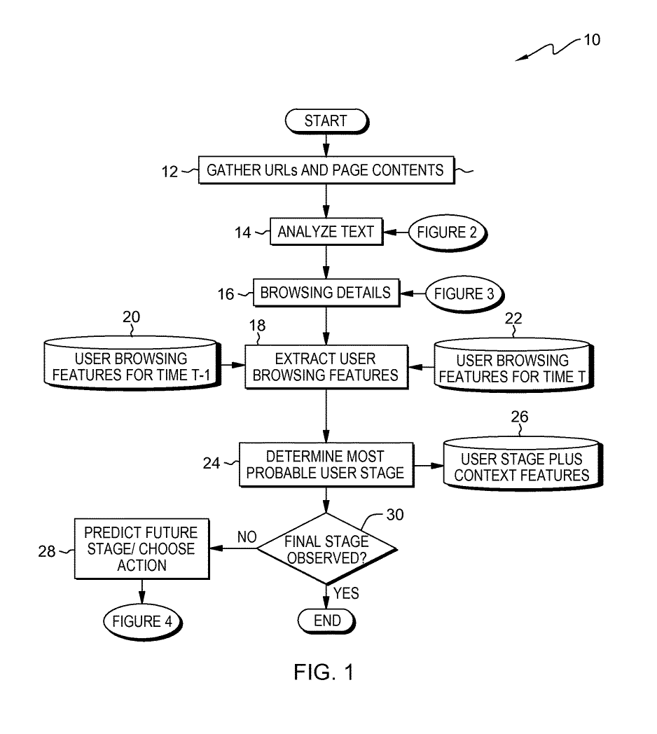

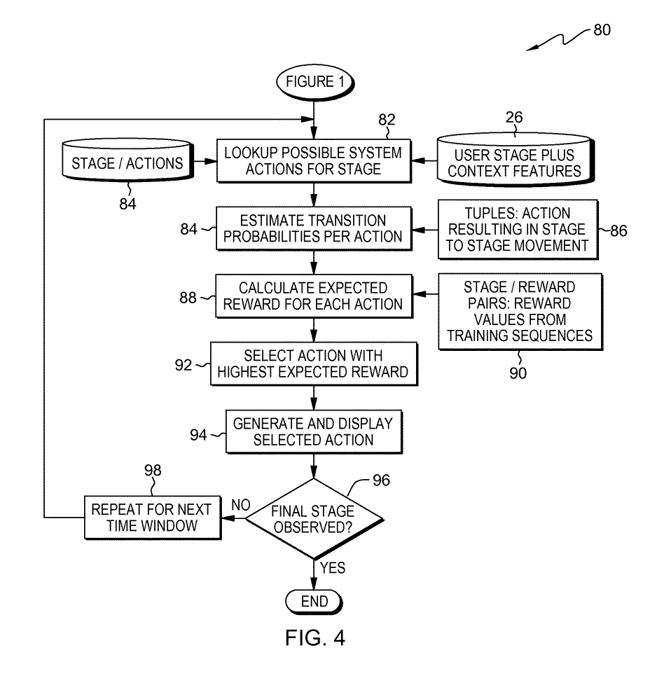

Referring to the drawings in more detail, FIG. 1 illustrates a process for detecting a current stage of an online user and FIG. 4 illustrates a process for generating an action to influence the user towards the last stage which may be to purchase a product or service or to close a contract for example.

Referring first to FIG. 1, the process 10 for detecting a current stage of an online user will be explained in more detail. The process 10 may occur in a predetermined time window. The process 10 may begin by gathering the URLs, and the page contents of those URLs, that the user has visited over the predetermined time period, box 12. The most recent URLs and the corresponding page contents may be the most meaningful to learn the user's current online behavior as the user's online behavior may change over time as the user may, for example, explore other products or evaluate products that have already been explored.

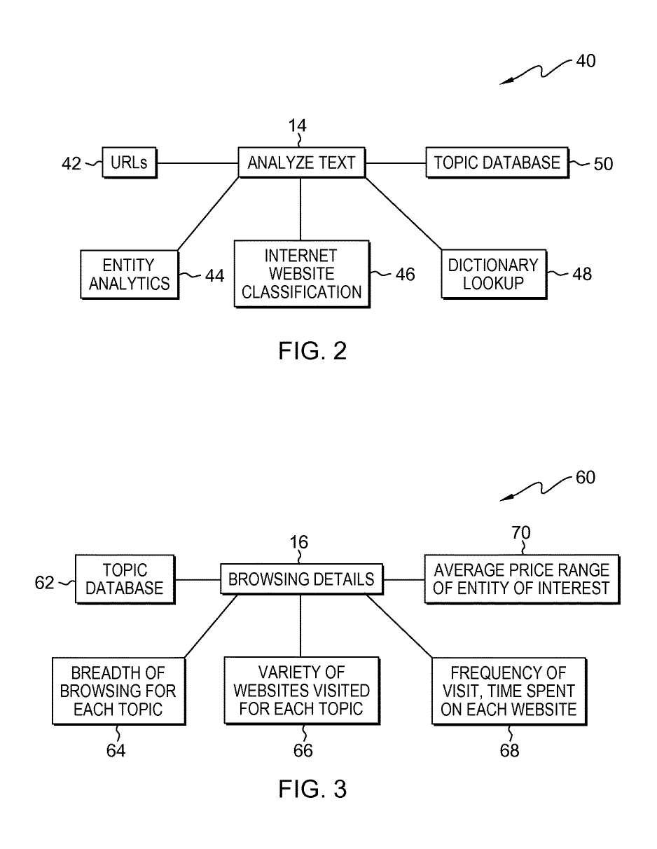

In a next step as indicated in block 14, the text of the URLs and the corresponding page contents just gathered may be processed using, for example, natural language processing. The analysis may take place by a process 40 illustrated in FIG. 2. Referring now to FIG. 2, available resources may be utilized to analyze and understand the URLs and the corresponding page contents including, but not limited to, the URLs themselves box 42, entity analytics 44, internet website classification which is a list of URLs classified by topic 46, dictionary lookup 48 and topic database 50 in conjunction with text analytics such as natural language processing. Thus, the text of the URLs and the corresponding page contents are analyzed by varying means to understand the contents of what the user is looking at.

The topic database 50 may be a compendium of topics of interest viewed by the present user or past users and stored in a database for future use.

Regarding entity analytics, an entity may be defined as a real world thing capable of an independent existence that can be uniquely identified. An entity is a thing that may exist either physically or logically. An entity may be a physical object such as a house or a car (they exist physically), an event such as a house sale or a car service, or a concept such as a customer transaction or order (they exist logically—as a concept). Entity analytics thus looks for entities and their relationships with other entities.

Entity analytics is a natural language processing task that assigns semantic types to terms such as Named Entities, common noun concepts, and events within natural language text. For example, in a sentence such as “Frigidaire, founded in 1882, is the leading maker of home appliances in the U.S.” the term ‘Frigidaire’ would be identified as a proper name and also a company, the term 1882 would be identified as a year, ‘home appliances’ would be identified as a product category, and the term ‘U.S.’ would be identified as a proper name, a country, and possibly other entity types if there are other meanings for the abbreviation U.S. in the entity analytics lexicon. Relations between the discovered entities may also be extracted, typically as subject-verb-object tuples. An example from the above sentence is Frigidaire/founded/1882.

Referring back to FIG. 1, the output of analyze text, box 14, in the previous step is the browsing details, box 16. The browsing details are illustrated in more detail in FIG. 3.

Referring now to FIG. 3, the outputs 60 that comprise the browsing details 16 may include, for example, a topic database 62, a breadth of browsing for each topic 64, the variety of websites visited for each topic 66, the frequency of visit to each website and the time spent on each website 68, and the average price range of entity of interest 70. The browsing details 16 are in the form of structured data. The browsed content input to the analyze text, box 14, is in the form of raw data.

Structured data may be viewed as extracted details that are organized into predictable data structures such as the subject-verb-object triplet above. Raw data includes all of the word tokens on the page which have not yet been analyzed to divide them into content words vs. functional connectors or to identify how individual word tokens relate to each other. Raw data is typically arranged in sequential order and treated as word windows or populated into vectors as lexical features. An example lexical feature would be to use the symbol ‘U.S.’ from the above example as the value of a feature without inferring its category such as Country.

Referring back to FIG. 1, the browsing details, box 16, are an input to the next step which is to extract user browsing features for a predetermined time window, box 18. In this step, the user's browsing features such as product category, product, brand, etc. may be extracted for time windows t−1, a previous time the user browsed, box 20, and t, the features for the user's current browsing session, box 22. The user's features for the previous browsing session may be obtained by the same means as the present browsing session. That is, subjecting the page content to entity analytics, user actions, etc.—all the features that are inputs for the stage calculation. Time stamps may be used for when the URL was visited by the user to determine which session is a previous browsing session. That the previous browsing session was the user's previous browsing session may be determined from the user's persistent logon, the user's IP (internet protocol) address, cookies or any other method known now or in the future. By comparing a previous browsing session with the present browsing session, a better understanding of the user's present online behavior may be obtained. For example, comparing features such as the number of products examined during the time window may give an indication of whether the user is in stage S1 or stage S2.

In a next process step, the most probable user stage is determined, box 24. Knowing the features in the user's present browsing session, the user's most probable stage may be determined by a classifier mechanism. That is, using a technique such as Baysian reasoning or regression in which there is supervised learning based on the browsing features that the user or previous users may have browsed for in the past, the user's present browsing features may be classified in one of the possible stages such as S1 to S4 as discussed above.

The process 10 then proceeds to decision box 30 where if the user is in the final stage such as S4, the process 10 proceeds down the “yes” branch and the process 10 may end. That is, since the user is in stage S4 and is going to purchase a product or has purchased the product, there is no longer any need to follow this user in this browsing session time window because there is no longer any online behavior to influence. However, it may be desirable to continue to follow the user's online behavior, and perhaps provide additional influential stage S4 actions such as celebrity endorsements, to make sure that the user actually completes the purchase.

However, if the user has not reached the final stage, then the process 10 may proceed along the “no” branch to predict a future stage and choose an action, box 28.

The user's current stage has been determined and so the process 10 proceeds to generate an action(s) that may influence the buyer to make a purchasing decision. The process 10 continues in FIG. 4. The user's most probable stage is stored to the user stage plus context features, box 26, for later use in the process 80 illustrated in FIG. 4. Context features may be place/time/and user model attributes if known, such as age, gender, profession.

Referring now to FIG. 4, there is disclosed the process 80 in which actions relevant to the current stage of the user are generated to influence the buyer to transition to the next stage. Possible actions for each stage may be stored in storage, box 84. The current stage of the buyer is stored in storage, box 26, which was determined from FIG. 1.

The list of possible actions is not static and may change as the context requires to provide actions that are the most probable to influence the user. These actions may be resorted to in the step of the process where the system looks up possible system actions for the current stage of the user, box 82. These actions are only relevant to the user in a particular time window as the user's behavior may and usually does change over time. In FIG. 1, the user was studied for a time window t+1 to determine the user's stage. The time window in FIG. 4 now may be t+2. The time window may be short enough so that there is no change in stage between t+1 and t+2. It may even be that If the time window is long enough, the user may still actually be in the same time window, t+1, as in FIG. 1.

In order to choose an appropriate action, the system may rely on, for example, reinforcement learning, from previous users who were at the same stage as the current user of the process. For example, assuming the stage of the user is S2: evaluation, the action may be to display to the user a link to a price/value comparison tool because such a link has been found to be influential to previous users who were at the same stage as the user to optimize the expected probability of reaching a successful sales conversion as the final stage of the process 80.

In a next step, the transition probabilities for each action are estimated, box 84. That is, based on previous reinforcement learning, for example, of many previous instances of a user's behavior in a given stage, probabilities of the user going to the next stage may be estimated.

Input to estimating the transition probabilities, box 84, may be tuples such as “from stage”/action/“to stage”, box 86, such as “stage S2/clickbait/stage S3”. Tuples may be combinations of stages and actions in which a particular action was successful in influencing a user to transition from one stage to another stage. In the example above, providing a clickbait link to the user in stage S2 was successful in influencing the user to transition to stage S3.

Central to a learned model such as reinforcement learning are training instances. Training instances are sequences of observations of user behavior gathered from a large user population and additional optional user context variables such as interests, demographic profile, etc. The decision space is modeled as a set of stages with two properties:

1) the allowable transitions between stages where each stage S_t has a finite set of reachable stages S_t+1.

2) the actions possible in stage S1 that lead to those next stages, with optional probabilities learned by examining training instances. For example, 20% of the time, taking action A1 in stage S1 may lead to stage S2, or taking action A2 in stage S1 may have X % probability of leading to S2, with a conditional probability that depends on user context variables. The collection of 52 stages reachable from each S1 for the probability model is observed from actual sequences and the values of S2 may be inferred (i.e. the assignment of a stage value within the training sequences might be calculated by a classifier) as described above or it may have been explicitly encoded in the data observations (such as via http meta tags) or it may be manually-added to the collected training instances.

Action selection aims to optimize the expected value of possible ‘to’ stages, where expected values may be described as “reward”. In a next step of the process 80, an expected reward is calculated for each action, box 88.

Reward is a value determined for each stage during training, and represents an expected payoff (or penalty) for the system when a user in this stage eventually reaches a final stage, such as sales conversion. In a sample training process, for each user who reached a final stage such as making a purchase, the reward variable for the final stage may be calculated as the amount (in currency) that particular user spent. The reward need not be a dollar value but could be some other quantity. A training process such as reinforcement learning pulls a portion of that reward value back through the network through the stages that the user had been in on his way to the final stage. After running this reward calculation process over many training instances, the interim stages that many users visited enroute to a successful final stage are left with a higher expected reward value than other stages where the user may have stalled or abandoned the purchase process. The result is stage/reward pairs which are reward values from the training sequences, box 90. The reward determined here is an input to calculate the expected reward for each action to determine action/reward pairs, box 88.

Stage/reward pairs determined above may be input to calculate an expected reward for each action. Because each action has a pre-calculated probability of influencing the user to progress to each particular next stage, and each of those stages has been given a calculated reward value during the training process, each action may be assigned an expected reward value for transitioning to the next step by calculating a weighted sum of the reward of reachable states.

For example, if selecting an action A1 in stage S2 has a 0.10 chance of transitioning to stage S4, and stage S4 has a reward value of 200 (as determined above), and actin A1 in stage S2 has a 0.90 chance of transitioning to stage S3, and stage S3 has a reward value of 50 (as determined above), then the expected reward of A1 in S2 is (0.1×200+0.9×50)=20+45=65. Thus, the expected reward can be calculated for each action available in stage S2 so that the system can produce the action with the highest expected reward. The action/reward pair in this example is A1/65.

More generally, the action/reward pair may be calculated by the following process. Of the actions possible in the origination or “from” stage, choose an action A where:

Action A=Max(reward(A_n)) over the n actions possible in the origination stage.

Reward(A_n) is the weighted sum over all destination or “to” stages T*R for the action A where:
T=transition probability of reaching the destination stage given A_n in the origination stage; and
R=the reward(value) of the destination stage, calculated by the training process.

The training process using reinforcement learning seeds all the stages with initial reward values, for example each non-final stage has an initial reward of 0 or some small random number, each success stage=1 and each failure stage=−1 (for example customer abandons cart). For training the reward values, action sequences are started in random stages, and then run forward until a final stage is reached. A reward update function is executed after each stage transition, in which a portion of the current reward of the ‘to’ stage is added to the reward value of the origination stage.

Action selection during training typically includes a certain small percent of random exploration. For example, the training may choose the highest-expected-reward action 90% of the time and a random action 10% of the time, to encourage exploration of the search space. After running many iterations, action sequences that lead to a successful final stage will have received a boosted expected reward and action sequences that lead to failure will have accumulated negative value. Training concludes when the reward values converge, or after a set (large) number of iterations.

While the training above was accomplished using reinforcement learning, the process for estimating the reward for each action may be easily modified for other learned models.

Once the expected rewards for each action have been calculated, an action with the highest calculated reward may be selected, box 92.

The selected action appropriate to the user's stage may then be generated and displayed to the user, box 94.

The user's online behavior is then evaluated to see if the user has reached the final stage, for example S4, box 96. If the user has reached the final stage, the process 80 proceeds down the “yes” branch and the process 80 ends. If the user has not reached the final stage, the process 80 proceeds along the “no” branch, and the process is repeated for the next time window box 98. Since the foregoing process steps for FIG. 4 took place in the t+2 time window, the incremented time window will be the t+3 time window.

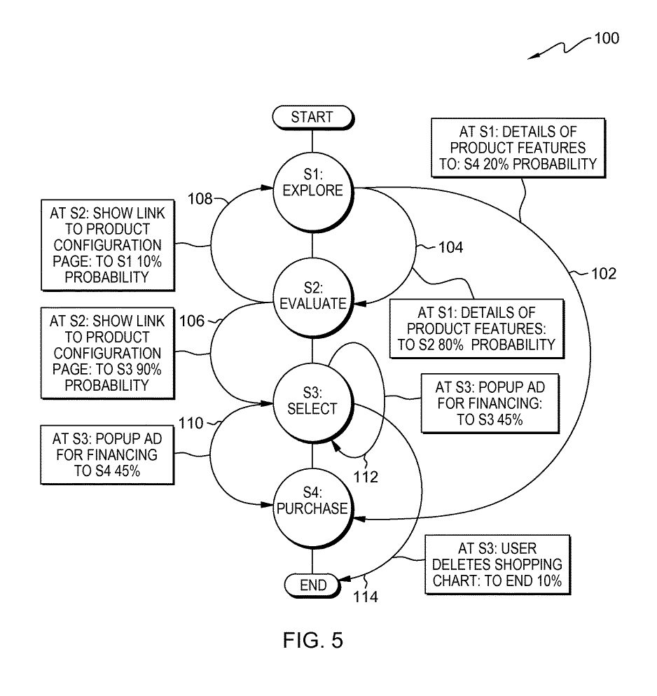

Referring now to FIG. 5 there is illustrated a sample stage/action transition model with transition probabilities. It should be understood that the actions and probabilities in FIG. 5 are only for the purpose of illustration and not limitation. FIG. 5 contains the same four stages S1 through S4 described earlier. In an ideal case, a user would progress orderly through the stages from S1 to S2 to S3 and finally to S4. However, as illustrated in FIG. 5, there are also probabilities for a user to progress directly from S1 to S4 or to progress backwardly from S2 to S1 or other possibilities as well.

In one scenario, details of product features have been provided to the user in stage S1. According to the process described previously with respect to FIG. 4, there is an 80% probability that a user will follow path 104 and transition to stage S2 indicating that a user may wish to do some in-depth evaluation of the product. However, there is also a 20% probability that the user will transition directly to stage S4 along path 102 indicating that the user has enough information and may simply wish to just purchase the product.

In another scenario, a link to product configuration has been shown to a user in stage S2. According to the process described previously with respect to FIG. 4, there is a 90% probability that a user will follow path 106 and transition to stage S3 to select a product. However, there is also a 10% probability that the user will follow path 108 and transition back to stage S1 to explore more product offerings.

In a further scenario, a popup ad has been shown to a user in stage S3. According to the process described previously with respect to FIG. 4, there is a 45% probability that a user will follow path 110 and transition to stage S4 to purchase a product. There is also a 45% probability that the user will follow path 112 and stay in stage S3 to select another product. There may also be a 10% probability that the user deletes his shopping cart or otherwise quits browsing and follows path 114.

The foregoing stage/action/probability model may be used for two purposes. One purpose may be to estimate how likely a user is to enter the stage S4 purchase stage after 1, 2 or N time units. Another purpose may be to choose system actions that might increase the likelihood of a user buying a product.

Throughout this description, the exemplary embodiments have been described with respect to purchasing a product. However, it should be understood that the exemplary embodiments have applicability to a wide variety of transactions including but not limited to sales of a service, rental of a product, providing of a service or any other transaction.

The exemplary embodiments may also include a system for detecting and generating online behavior from a clickstream. The system may include a specially programmed computer device. The computer device may have a computer readable storage medium, the computer readable storage medium having program code embodied therewith, the computer readable program code may perform the method of FIGS. 1 to 4.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method of detecting and generating online behavior from a clickstream comprising:
learning a user's present stage of online behavior wherein there are a plurality of stages of online behavior from exploring at least one product or service to purchasing at least one product or service;
responsive to learning the user's present stage of online behavior, predicting a user's future stage of online purchasing behavior; and
providing a targeted online action to the user in conjunction with predicting the user's future stage of online purchasing behavior to influence the user to a next stage of online behavior.

2. The method of claim 1 further comprising learning, predicting and providing until a final stage is attained wherein at least one product or service is purchased.

3. The method of claim 1 wherein learning a user's present stage of online behavior comprises:
gathering the URLs and page contents viewed by the user in a predetermined time window;
analyzing the text of the user's URLs and page contents to understand the user's URLs and page contents viewed by the user;
extracting the user's browsing features from the analyzed user's URLs and page contents viewed by the user for the predetermined time window and comparing to the user's browsing features from a previous time window; and
responsive to extracting the user's browsing features, determining the user's most probable stage of online behavior with respect to purchasing the product or service.

4. The method of claim 3 wherein the predetermined time window is a time window that varies according to the user's online behavior with respect to purchasing the product or service.

5. The method of claim 2 wherein responsive to extracting the user's browsing features, outputting the user's stage of online behavior with respect to purchasing the product or service.

6. The method of claim 1 wherein the plurality of stages of online behavior comprise exploring at least one product or service, evaluating the at least one product or service, selecting the at least one product or service and purchasing the at least one product or service.

7. The method of claim 1 wherein predicting a user's future stage of online purchasing behavior, and providing a targeted online action to the user in conjunction with predicting the user's future stage of online purchasing behavior to influence the user to transition to a next stage of online behavior comprises:
receiving as an input the user's stage of online behavior with respect to purchasing the product or service;
retrieving possible actions for the user's particular stage of online behavior to influence the user to transition to a next stage of online behavior with respect to purchasing the product or service;
estimating probabilities for each possible action to transition the user to the next stage of online behavior with respect to purchasing the product or service;
selecting an action having a highest expected reward to influence the user to transition to the next stage of online behavior with respect to purchasing the product or service such that the expected reward is calculated according to the following;
Expected Reward (A_n) is the weighted sum over all possible destination stages of T*R where:
(1) Action A=Max(reward(A_n) is an action A over the n actions possible in an origination stage to result in a maximum value for a final stage as calculated by a training process
(2) T=transition probability of reaching a destination stage given A_n in the origination stage
(3) R=the value of the maximum reward of the destination stage calculated by the training process when action A is selected;
generating the selected action; and
displaying the selected action to the user.

8. The method of claim 7 wherein estimating probabilities includes inputting a plurality of tuples comprising a from stage, an action that was previously successful in transitioning the user to a next stage of online behavior with respect to purchasing the product or service and the next stage.

9. The method of claim 1 wherein predicting a user's future stage of online purchasing behavior, and providing a targeted online action to the user in conjunction with predicting the user's future stage of online purchasing behavior to influence the user to a next stage of online behavior comprises:
for a predetermined time period:
receiving as an input the user's stage of online behavior with respect to purchasing the product or service;
retrieving possible actions for the user's particular stage of online behavior to influence the user to transition to a next stage of online behavior with respect to purchasing the product or service;
estimating probabilities for each possible action to transition the user to the next stage of online behavior with respect to purchasing the product or service;
selecting an action having a highest expected reward to influence the user to transition to the next stage of online behavior with respect to purchasing the product or service such that the expected reward is calculated according to the following; Expected Reward (A_n) is the weighted sum over all possible destination stages of T*R where:
(1) Action A=Max(reward(A_n) is an action A over the n actions possible in an origination stage to result in a maximum value for a final stage as calculated by a training process
(2) T=transition probability of reaching a destination stage given A_n in the origination stage
(3) R=the value of the maximum reward of the destination stage calculated by the training process when action A is selected;
generating the selected action; and
displaying the selected action to the user; and
repeating the steps of receiving, retrieving, estimating, selecting, generating and displaying for a next time period.

10. The method of claim 9 wherein the predetermined time window is a time window that varies according to the user's online behavior with respect to purchasing the product or service.

11. The method of claim 9 wherein estimating probabilities includes inputting a plurality of tuples comprising a from stage, an action that was previously successful in transitioning the user to a next stage of online behavior with respect to purchasing the product or service and the next stage.

12. The method of claim 7 wherein possible actions are customized to the user's stage of online behavior with respect to purchasing the product or service.

13. A computer program product for detecting and generating online behavior from a clickstream comprising a computer readable storage medium having program instructions embodied therewith, the program instructions executable by a computer to cause the computer to perform a method comprising:
learning a user's present stage of online behavior wherein there are a plurality of stages of online behavior from exploring at least one product or service to purchasing at least one product or service;
responsive to learning the user's present stage of online behavior, predicting a user's future stage of online purchasing behavior; and
providing a targeted online action to the user in conjunction with predicting the user's future stage of online purchasing behavior to influence the user to a next stage of online behavior.

14. The computer program product of claim 13 wherein learning a user's present stage of online behavior comprises:
gathering the URLs and page contents viewed by the user in a predetermined time window;
analyzing the text of the user's URLs and page contents to understand the user's URLs and page contents viewed by the user;
extracting the user's browsing features from the analyzed user's URLs and page contents viewed by the user for the predetermined time window and comparing to the user's browsing features from a previous time window; and
responsive to extracting the user's browsing features, determining the user's most probable stage of online behavior with respect to purchasing the product or service.

15. The computer program product of claim 13 wherein the predetermined time window is a time window that varies according to the user's online behavior with respect to purchasing the product or service.

16. The computer program product of claim 13 wherein the plurality of stages of online behavior comprise exploring at least one product or service, evaluating the at least one product or service, selecting the at least one product or service and purchasing the at least one product or service.

17. The computer program product of claim 13 wherein predicting a user's future stage of online purchasing behavior, and providing a targeted online action to the user in conjunction with predicting the user's future stage of online purchasing behavior to influence the user to a next stage of online behavior comprises:
for a predetermined time period:
receiving as an input the user's stage of online behavior with respect to purchasing the product or service;
retrieving possible actions for the user's particular stage of online behavior to influence the user to transition to a next stage of online behavior with respect to purchasing the product or service;
estimating probabilities for each possible action to transition the user to the next stage of online behavior with respect to purchasing the product or service;
selecting an action having a highest expected reward to influence the user to transition to the next stage of online behavior with respect to purchasing the product or service such that the expected reward is calculated according to the following:
Expected Reward (A_n) is the weighted sum over all possible destination stages of T*R where:
(1) Action A=Max(reward(A_n) is an action A over the n actions possible in an origination stage to result in a maximum value for a final stage as calculated by a training process
(2) T=transition probability of reaching a destination stage given A_n in the origination stage
(3) R=the value of the maximum reward of the destination stage calculated by the training process when action A is selected;
generating the selected action; and
displaying the selected action to the user; and
repeating the steps of receiving, retrieving, estimating, selecting, generating and displaying for a next time period.

18. The computer program product of claim 17 wherein the predetermined time window is a time window that varies according to the user's online behavior with respect to purchasing the product or service.

19. The computer program product of claim 17 wherein estimating probabilities includes inputting a plurality of tuples comprising a from stage, an action that was previously successful in transitioning the user to a next stage of online behavior with respect to purchasing the product or service and the next stage.

20. A system for detecting and generating online behavior from a clickstream comprising:
a specially programmed computer device;
the specially programmed computer device having a computer readable storage medium, the computer readable storage medium having program instructions embodied therewith, the program instructions executable by the specially programmed computer device to cause the specially programmed computer device to perform a method comprising:
learning a user's present stage of online behavior wherein there are a plurality of stages of online behavior from exploring at least one product or service to purchasing at least one product or service;
responsive to learning the user's present stage of online behavior, predicting a user's future stage of online purchasing behavior; and
providing a targeted online action to the user in conjunction with predicting the user's future stage of online purchasing behavior to influence the user to a next stage of online behavior.
